(19) United States
(12) Patent Application Publication
(10) Pub. No.: US 2015/0381465 A1
(43) Pub. Date: Dec. 31, 2015

(54) Real Time Verification of Cloud Services with Real World Traffic

(71) Applicant: Microsoft Corporation, Redmond, WA (US)

(72) Inventors: Rajagopalan Narayanan, Redmond, WA (US); Chetan Pentam Raghavendra, Kirkland, WA (US)

(21) Appl. No.: 14/316,589

(22) Filed: Jun. 26, 2014

(51) Int. Cl. H04L 12/26

(52) U.S. Cl. CPC H04L 43/50; H04L 43/062

(57) ABSTRACT

Using real world network traffic for both a primary and ancillary system. A method includes accessing intercepted network traffic directed to a primary system. The intercepted network traffic is real network traffic sent by entities sending messages directed to the primary system. One or more policy constraints are identified on network traffic to be used at an ancillary system. Based on the one or more policy constraints, a subset of the intercepted network traffic is identified. The subset of the intercepted traffic is sent to the ancillary system, where the subset of the intercepted traffic is consumed by the ancillary system.

### BACKGROUND

### Background and Relevant Art

Computers and computing systems have affected nearly every aspect of modem living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Web services are networked computing systems that can provide data and computing services to client devices. Services are continually becoming more complex as they enable new features in a competitive services landscape. Before a new service or an updated version of a service goes live for servicing client requests, the service should be verified for different combinations of user input, configuration settings, device diversity, application diversity, etc. To test for all possible combinations of user input, setup, and devices is very costly and becomes more challenging as features are being developed and/or revised at quicker and quicker paces.

Solutions have focused on traditional verification which involves setting up non-production environments with simulated network traffic and weeks of verification by quality assurance teams.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for using real world network traffic for both a primary and ancillary system. The method includes accessing intercepted network traffic directed to a primary system. The intercepted network traffic is real network traffic sent by entities sending messages directed to the primary system. One or more policy constraints are identified on network traffic to be used at an ancillary system. Based on the one or more policy constraints, a subset of the intercepted network traffic is identified. The subset of the intercepted traffic is sent to the ancillary system, where the subset of the intercepted traffic is consumed by the ancillary system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more filly apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example environment where network traffic can be duplicated and used for testing systems;

FIG. 2 illustrates a method of testing using real world network traffic; and

FIG. 3 illustrates another method of testing using real world network traffic.

### DETAILED DESCRIPTION

Some embodiments illustrated herein implement testing by copying real network traffic that is being sent to a functioning service (or other system) servicing real clients, filtering the copied network traffic to obtain desired test network traffic characteristics and sending the filtered test network traffic with the desired characteristics to one or more test (or other) services (or other systems). Optionally, embodiments may modify, duplicate multiple times, or otherwise manipulate real network traffic to create test network traffic conforming to desired characteristics.

Thus, some embodiments can enable services to get real time verification by consuming existing customer traffic without impacting the customer experience or service reliability. Thus, for example, consider a production system running a service of version ‘n’ taking real traffic from and providing real services to clients. Embodiments may facilitate real time duplication of traffic to version ‘n+1’ (and/or versions ‘n+2’, ‘n+3’, . . . etc.) end points without impacting original traffic to the system running the service of version n from a quality or reliability point of view. The version n+1 may be a non-production system for which services provided or data generated is not actually provided to real-world clients. Embodiments may additionally implement policy driven decisions. Such decisions may be based on policy defining what data to duplicate. Alternatively or additionally, such decisions may be based on policy defining where to duplicate data. For example, policy may define what test system should receive duplicated data and how that data should be delivered. Alternatively or additionally, such decisions may be based on policy defining how much of the real time network data to duplicate. Alternatively or additionally, such decisions may be based on policy defining how real time network data should be duplicated. Alternatively or additionally, such decisions may be based on policy defining how to deal with differences in behavior between test services and live services servicing actual clients.

While embodiments are illustrated herein using services, it should be appreciated that other systems may be used in other embodiments of the invention. In particular, a service is a particular type of system in which embodiments may be implemented. However, other types of systems may be used. Thus, while the examples herein refer to services, it should be appreciated that this is only for illustration purposes, and other systems could be used in conjunction with, or instead of the illustrated services.

Some embodiments may include functionality for implementing real time analysis of telemetry streams based on heuristics and/or machine learning to flag potential issues in test services.

Some embodiments may be able to implement real time feedback on the differences in the form of reports and alerts generated by analyzing test services or comparing test services to live services. Reports can show functional differences and performance differences based on pre-determined and pre-configured pivots. The feedback may be implemented in a closed loop which allows embodiments to refine analysis algorithms and/or policy constraints.

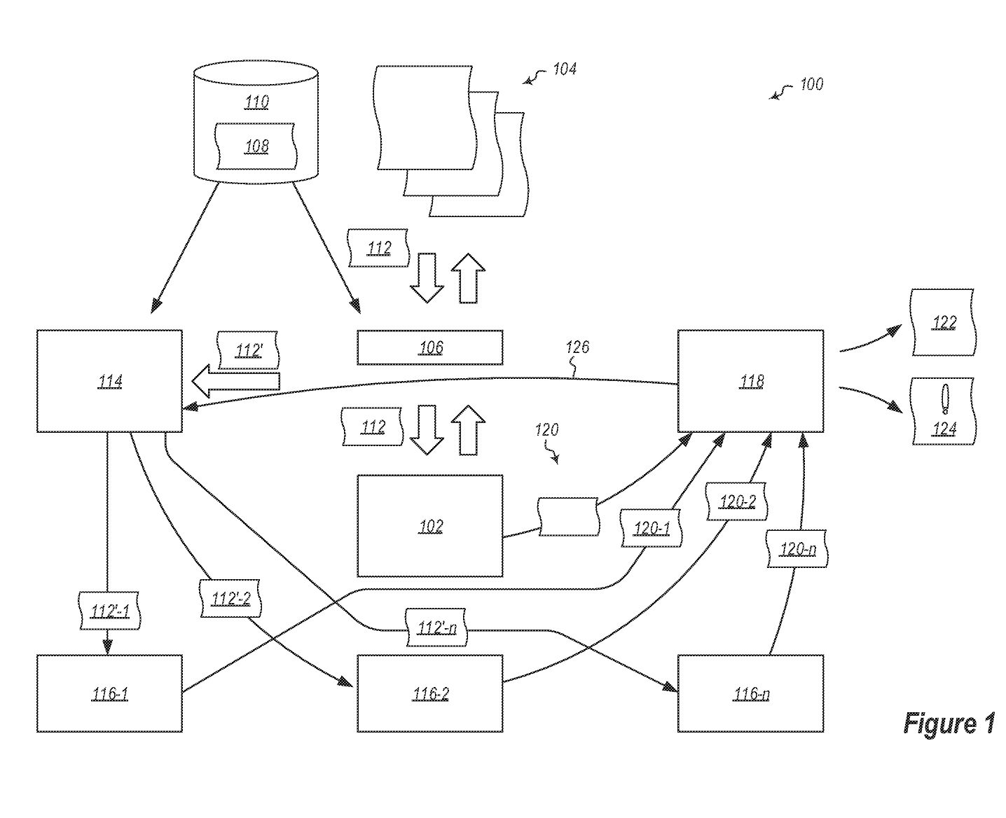

Details are now illustrated; reference is now made to FIG. 1, which illustrates a service environment 100. In the service environment 100 is a service 102 configured to provide data and/or services to one or more client systems 104. Network traffic between the service 102 and the client systems 104 travels through a gateway 106. In some embodiments, the gateway 106 may implement a reverse proxy. In some embodiments, the gateway 106 is the component where the customer terminates in a datacenter.

The gateway 106 may be implemented in some embodiments as an Internet Information Services (IIS) Application Request Routing (ARR) module available from Microsoft Corporation of Redmond, Wash. In an alternative or additional embodiment, the gateway 106 may be implemented as a custom HTTP service. The gateway 106 can consult policies 108 stored in a policy store 110. This may be done, for example, to determine whether or not requests 112 from the clients systems 104 need to be duplicated. Additionally or alternatively, the policies 108 can dictate how requests should be duplicated.

The gateway 106 may further be configured to queue a subset 112′ of the requests 112 for duplication to a gateway traffic forking broker service 114. The subset 112′ is forwarded to the gateway traffic broker forking service 114 and the requests 112 are forwarded to the service 102, where the requests 112 are consumed. As a result, the service 102 can respond with data and/or services to the clients 104. Note that in some embodiments, rather than the subset 112′ being sent to the gateway traffic broker forking service 114, all requests 112 may be sent to the gateway traffic broker forking service 114 and policy may be applied at the gateway traffic broker forking service 114 to determine subset(s) of the request(s) to be sent to test services, where the subset(s) are consumed. In some embodiments, the gateway 106 and the gateway traffic broker forking service 114 may be co-located and implemented together as a single system. The gateway traffic broker forking service 114 can change headers of requests to cause them to be routed to the appropriate services (i.e., the test services 116-1, 116-2 through 116-n). Such headers may be referred to herein as forking headers.

The gateway traffic forking broker service 114 receives the duplicated request in the subset 112′ from the queue and uses the policies 108 at the policy store 110 to drive more detailed decisions on how to duplicate the requests. Powerful policies can be defined enabling a developer to obtain a network traffic profile that they are interested in for providing test traffic to test services. For example, requests may be duplicated in a fashion to create network traffic with custom profiles. Traffic can have custom profile characteristics with respect to client user agents, protocols, locations, client device type, etc. Thus for example, embodiments could use policies 108 to ensure that test traffic contained certain percentages of mobile phone traffic, PC traffic, application specific traffic, traffic using specific protocols, traffic coming from specific locations, etc.

A test service can be, for example, a cloud service with HTTP endpoints, or any other appropriate service. FIG. 1 illustrates a plurality of test services 116-1, 116-2 through 116-n that can consume the duplicated traffic. In some embodiments, the test services may use HTTP as the way a customer interacts with the test service. Note that while the services 116-1 through 116-n are referred to as test services, it should be appreciated that in other embodiments, other services or systems, including services or systems not being tested, may be implemented in a similar fashion within the scope of embodiments of the present invention.

As shown in FIG. 1, the production service 102 and the test services 116-1, 116-2 through 116-n are running side by side. In the illustrated example, different subsets 112′-1, 112′-2 through 112′-n of the subset 112′ may be sent to the different test services 116-1, 116-2 through 116-n respectively. The subsets 112′-1 through 112′-n may be subsets of traffic that are specially crafted with certain characteristics appropriate for the test services 116-1 through 116-n as defined by the policies 108. However, in some embodiments, all of the different test services 116-1 through 116-n may receive the same subsets of traffic. For example, one may wish to compare different services under the same constraints.

In some embodiments, the test services 116-1, 116-2 through 116-n may be new or planned versions of the production service 102. Alternatively, one or more of the test services may be other planned services that, although unrelated to the production service 102 or less related than a different version of the production service 102, may nonetheless expect traffic similar to that experienced by the production service 102. Note that while a plurality of test services is shown, other embodiments may be implemented where only a single service is implemented.

Illustrating a very specific example, a production service 102 is running version n or the reference version of a service, which is the known good version taking customer requests 112. Version n+1 is the next version of the service where several code changes have gone in which need to be verified that it is on par in quality and reliability with the reference version. For example, version n+1 may be the test system 116-1.

Both version n and version n+1 services can run option modules to send additional telemetry info as part of the response headers for richer analysis. Telemetry refers to automated measurement and data collection processes. Thus, embodiments can implement telemetry processes, both for the production service 102 and a test service 116-1. Telemetry information for the two different services could then be compared to determine different responses of the services, performance issues with at least one of the services, or other issues for at least one of the services. When data is returned, the gateway 106 drops forking headers before sending a response back to a customer.

Some embodiments may implement an analysis service 118. The analysis service 118 correlates, in real time (in some embodiments), service responses from original requests 112 and duplicated requests in the subset 112′. For example, telemetry streams 120, 120-1, 120-2 through 120-n can be provided to the analysis service 118. The analysis service 118 can use this information for a number of different purposes. For example, the analysis service can use this information for generating reports, for issuing alerts, adjusting the policies 108 in a closed loop system, etc.

Illustrating now various examples, FIG. 1 illustrates a report 122 generated by the analysis service 118. The report 122 may include a summary of telemetry information, data generated from telemetry information, an analysis of how a test service compares to a production service, etc. This report can be used by network administrators to understand the health of a network, make service deployment considerations, or for other appropriate purposes.

FIG. 1 illustrates an alert 124. The alert may be generated by the analysis service 118 when the analysis service 118 detects an issue that should be identified to a network administrator or other appropriate entity. For example, the alert may be issued when the production system 102 and a test system 116-1 differ significantly in their response to request traffic and/or when such difference can be determined to indicate a problem with the production system and/or the test system 116. The alert 124 may be, for example, an email, a text message, an application notification, or other appropriate alert.

FIG. 1 further illustrates a feedback loop 126. The feedback loop 126 can be used to adjust the policies 108 and/or adjust how the gateway traffic forking broker service 114 and/or the gateway 106 copies and/or distributes requests.

Embodiments can provide an extensible way for adding rules that process responses to requests to determine whether responses should be flagged as anomalies. Embodiments may employ heuristics (e.g. a set of rules) and/or machine learning techniques to spot an anomaly for developer investigations. Anomalies flagged may be communicated to service owners through alerting and reports.

In some embodiments, duplicated traffic in the subset 112′ can be modified. For example, a duplicated request ay change or anonymize information from an original request intended for the production service 102. For example, the requests 112 may include sensitive and/or secret information. For example, the requests 112 may include user names and/or passwords, other account data, financial data, etc. Embodiments may include functionality for removing such data from the requests 112 when creating the subsets 112′. Alternatively, the data may be anonymized such that it cannot be correlated with an actual user. Thus, for example, in some embodiments, username and password data can be replaced with generic username and password data that can be used to access data and services at the test services 116-1 through 116-n.

In some embodiments other portions of duplicated traffic can be modified. For example, requests may be modified so as to appear as if they are corning from certain devices or applications, so that they appear to be of certain protocols, or for other reasons.

Embodiments can be applied in a number of various circumstances and situations. For example, some embodiments may be implemented to verify if a new service version n+1 is a functional and performance equivalent of a version n service in a production environment.

Alternatively or additionally, embodiments may be implemented to verify that version n+m is a functional and performance equivalent of version n with version n al running on a developer desktop.

Alternatively or additionally, embodiments may be implemented in a migration scenario where a user migrates from one provider to a completely different provider. For example, consider the case where an enterprise wishes to switch from one cloud provider to a different cloud provider. For example, the enterprise may wish to switch from cloud services provided by Amazon to Microsoft Azure. Each cloud provider provides compute, storage and network services. It would be useful, during the migration process, to compare the two services, and particularly the compute, storage and network services, that are the subject of the migration. This could be used for several different purposes, including verifying an error free migration, identifying problems resulting from a migration, or simply comparing two competing services for a customer to allow the customer to identify the more optimal solution for their circumstance. Such embodiments, or other embodiments, can alternatively, or additionally be used to verify that data storage on one service is consistent with data storage on a different service. For example, different services may store the same data differently, and thus it may be important to verify that in spite of these differences, the data is nonetheless accessed, used, and presented to users in a similar fashion, irrespective of how different services store and access the data.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

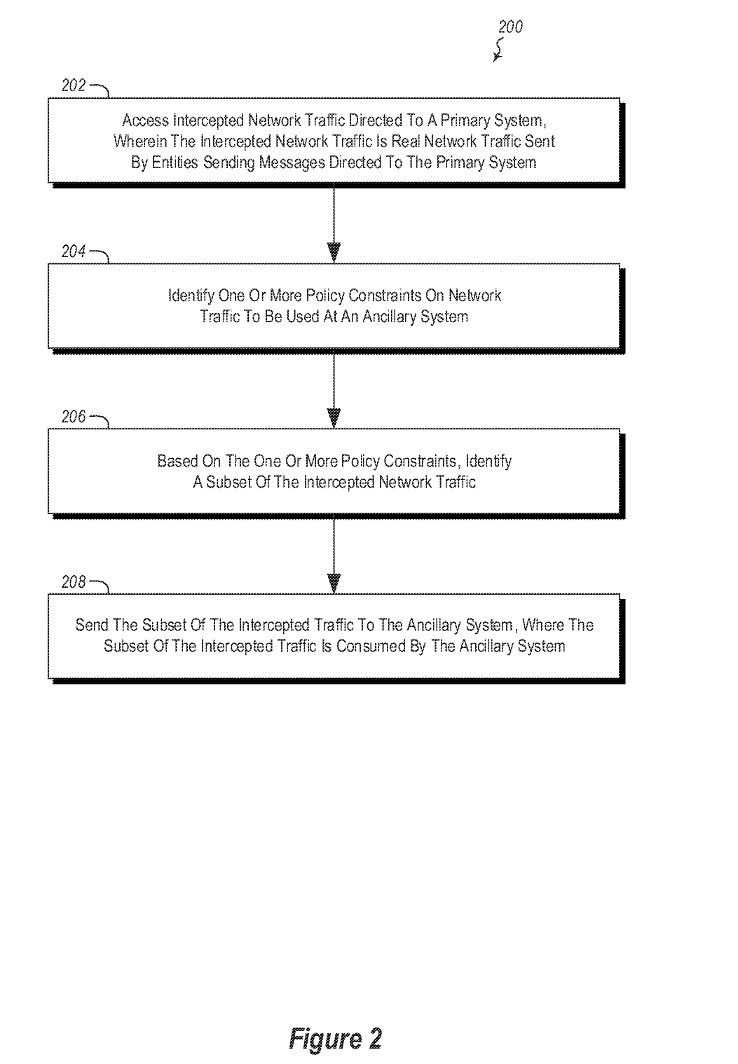

Referring now to FIG. 2, a method 200 is illustrated. The method 200 may be practiced in a computing environment. The method 200 includes acts for using real world network traffic for both a primary and ancillary system. The method 200 includes accessing intercepted network traffic directed to a primary system, wherein the intercepted network traffic is real network traffic sent by entities sending messages directed to the primary system (act 202). For example, as illustrated in FIG. 1, the gateway 106 may intercept requests 112 from the clients 104.

The method 200 further includes identifying one or more policy constraints on network traffic to be used at an ancillary system (act 204). For example, as illustrated in FIG. 1, policies 108 can be identified.

The method 200 further includes, based on the one or more policy constraints, identifying a subset of the intercepted network traffic (act 206), For example, as illustrated in FIG. 1, the subset 112′ may be identified based on the policies 108. Further, additional subsets 112′-1, 112′-2 through 112′-n may be identified based on the policies 108.

The method further includes sending the subset of the intercepted traffic to the ancillary system (act 208). For example, as illustrated in FIG. 1, the subsets 112′-1, 112′-2 through 112′-n are sent to test services 116-1, 116-2 through 116-n respectively. The subset of the intercepted traffic is consumed by the ancillary system.

The method 200 may be further based on an analysis of the behavior of the ancillary system as a result of consuming the subset of the intercepted traffic, and modifying the policy constraints on network traffic to be tested for subsequent traffic. Thus, for example, as illustrated in FIG. 1, the telemetry streams 120-1, 120-2 through 120-n are sent to the analysis service 118 which generates an analysis of the telemetry streams. In some embodiments, this may be used in conjunction with analysis of the telemetry stream 120 for the production service 102. This information can be used in the feedback loop 126 to adjust the policies 108. Alternatively or additionally, this information can be used to issue an alert, such as alert 124. Alternatively or additionally, this information can be used to issue a report, such as the report 122.

In some embodiments, analyzing the behavior of the ancillary system may include analyzing key performance indicators. Such key performance indicators may include one or more ancillary system metrics, ancillary system performance, ancillary system error rates, service level agreement (SLA) conformance, etc.

Some embodiments may further include analyzing client characteristics for clients creating intercepted network traffic in conjunction with analyzing the behavior of the ancillary system. This can be used to determine what kinds of traffic create what kinds of responses in the ancillary system. For example, client characteristics may include one or more of geographical location information of one or more clients, operating systems used by one or more clients, browsers or applications used by one or more clients, operating systems used by one or more clients, platforms used by one or more clients, headers produced by one or more clients, traffic lineage for one or more clients, protocols used by one or more clients, etc.

In some embodiments, the method 200 may include iteratively modifying the policy constraints on traffic to be tested to converge on an underlying error cause. Thus, for example, the feedback loop 126 can be used to indicate a test system response. Policy constraints in the policy 108 can be modified in an attempt to isolate the reason(s) for the system response. Thus for example, traffic with different characteristics can be sent to the test services 116-1 through 116-n to determine what traffic causes what system responses.

The method 200 may be practiced where the method is practiced in a system having a plurality of ancillary systems, and wherein at least a portion of the policy constraints on traffic to be tested indicate characteristics of traffic for routing certain traffic to certain ancillary systems. Thus, for example, as illustrated in FIG. 1, different subsets may be routed to different test services.

The method 200 may be practiced where at least a portion of the policy constraints identify characteristics of results from ancillary systems.

The method 200 may be practiced where the policy constraints identify security constraints to prevent secret or sensitive data from being delivered to an ancillary service. For example, as illustrated above, embodiments may include functionality for filtering out secret or sensitive data such as username and password. This may be especially useful in cases where an ancillary system is implemented as a test service on a developer's desktop.

The method 200 may be practiced where the policy constraints specify customized network traffic loads to specify that certain intercepted network traffic should duplicated to produce a desired network traffic load. For example, embodiments may create customized loads by duplicating certain requests a certain number of times and optionally other requests a different number of times to obtain some desired data profile and sending all of the duplicated requests to the same system.

The method 200 may be practiced where the policy constraints specify changes to be made to intercepted network traffic. For example, embodiments can change information in requests, change user agent information, header information, or other information as part of crafting data with a customized profile.

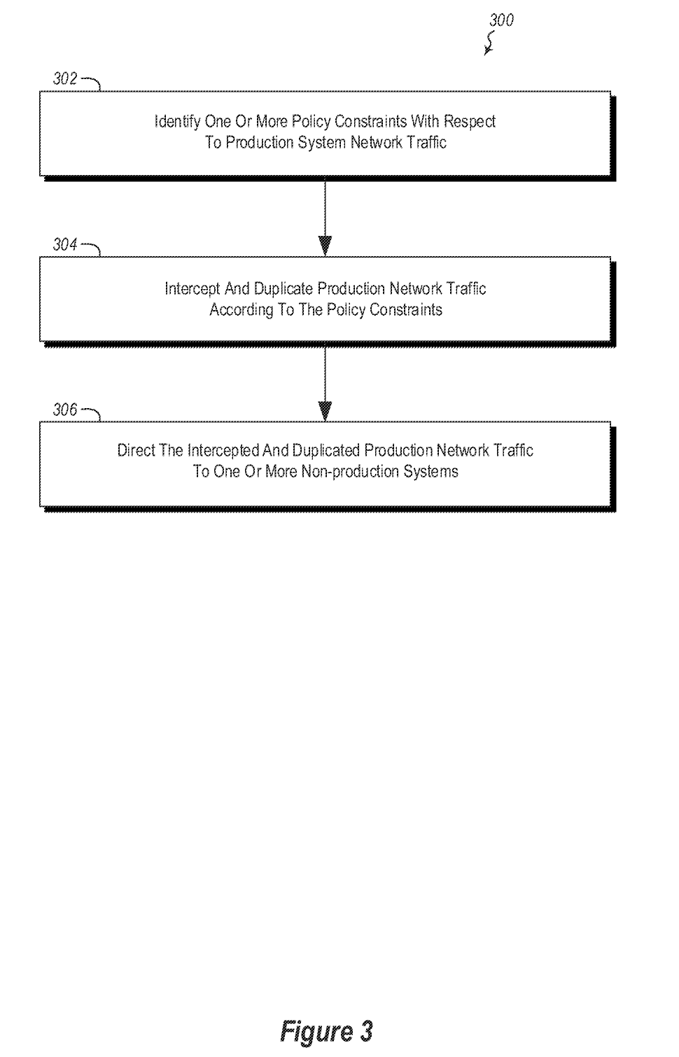

Referring now to FIG. 3, a method 300 is illustrated. The method includes acts for generating test network traffic. The method 300 includes identifying one or more policy constraints with respect to production system network traffic (act 302). For example, as illustrated in FIG. 1, policies 108 may be identified that include constraints. Various constraints that may be implemented have been previously illustrated above. For example, the policy constraints identify security constraints to prevent secret or sensitive data from being delivered to the one or more non-production systems. Alternatively or additionally, the policy constraints specify customized network traffic loads to specify how network traffic should be intercepted and duplicated to produce a desired network traffic load. Alternatively or additionally, the policy constraints specify changes to be made to duplicated network traffic. Other constraints not specifically mentioned here may alternatively or additionally, be used in the implementation of the method 300.

The method 300 further includes intercepting and duplicating production network traffic according to the policy constraints (act 304). FIG. 1 illustrates that portions of requests 112 are intercepted and duplicated to produce the subset 112′.

The method further includes directing the intercepted and duplicated production network traffic to one or more non-production systems (act 306).

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures, Such computer-readable media can be any available media that can be accessed by a general purpose or special purpose computer system. Computer-readable media that store computer-executable instructions are physical storage media Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which cat be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry the desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including but not limited to, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for using real world network traffic for both a primary and ancillary system, the system comprising:
a gateway, wherein the gateway is configured to intercept and duplicate network traffic directed to a primary system, wherein the intercepted network traffic is real network traffic sent by entities sending messages directed to the primary system;
a gateway traffic broker forking service, wherein the gateway traffic broker forking service is configured to apply policy constraints to intercepted network traffic to identify one or more subsets of the intercepted network traffic, wherein the gateway traffic broker forking service is further configured to route the one or more subsets of the intercepted network traffic to one or more ancillary non-production test systems.

2. The system of claim 1, wherein the gateway is configured to intercept and duplicate network traffic according to a policy.

3. In a computing environment, a method of using real world network traffic for both a primary and ancillary system, the method comprising:
accessing intercepted network traffic directed to a primary system, wherein the intercepted network traffic is real network traffic sent by entities sending messages directed to the primary system;
identifying one or more policy constraints on network traffic to be used at an ancillary system;
based on the one or more policy constraints, identifying a subset of the intercepted network traffic; and
sending the subset of the intercepted traffic to the ancillary system, where the subset of the intercepted traffic is consumed by the ancillary system.

4. The method of claim 3, further comprising based on an analysis of the behavior of the ancillary system as a result of consuming the subset of the intercepted traffic, modifying the policy constraints on network traffic to be tested for subsequent traffic.

5. The method of claim 4, wherein analyzing the behavior of the Ancillary system comprises analyzing key performance indicators.

6. The method of claim 5, wherein the key performance indicators comprises at least one of the one or more ancillary system metrics, ancillary system performance, ancillary system error rates, or service level agreement (SLA) conformance.

7. The method of claim 4, further comprising analyzing client characteristics for clients creating intercepted network traffic in conjunction with analyzing the behavior of the ancillary system.

8. The method of claim 7, wherein client characteristics comprise one or more of geographical location information of one or more clients, operating systems used by one or more clients, browsers or applications used by one or more clients, operating systems used by one or more clients, platforms used by one or more clients, headers produced by one or more clients, traffic lineage for one or more clients, or protocols used by one or more clients.

9. The method of claim 4, further comprising iteratively modifying the policy constraints on traffic to be tested to converge on an underlying error cause.

10. The method of claim 3, wherein the method is practiced in a system having a plurality of ancillary systems, and wherein at least a portion of the policy constraints on traffic to be tested indicate characteristics of traffic for routing certain traffic to certain ancillary systems.

11. The method of claim 3, wherein at least a portion of the policy constraints identify characteristics of results from the ancillary system.

12. The method of claim 3, wherein the policy constraints identify security constraints to prevent secret or sensitive data from being delivered to an ancillary system.

13. The method of claim 3, wherein the policy constraints specify customized network traffic loads to specify that certain intercepted network traffic should be duplicated to produce a desired network traffic load.

14. The method of claim 3, wherein the policy constraints specify changes to be made to intercepted network traffic.

15. The method of claim 3, further comprising, based on an analysis of the behavior of the ancillary system as a result of consuming the subset of the intercepted traffic, issuing an alert.

16. The method of claim 3, further comprising, based on an analysis of the behavior of the ancillary system as a result of consuming the subset of the intercepted traffic, issuing a report.

17. In a computing environment, one or more physical computer-readable storage media comprising computer-executable instructions that when executed by one or more processors cause the following to be performed:
identifying one or more policy constraints with respect to production system network traffic;
intercepting and duplicating production network traffic according to the policy constraints; and
directing the intercepted and duplicated production network traffic to one or more non-production systems.

18. The one or more physical computer-readable storage media of claim 17, wherein the policy constraints identify security constraints to prevent secret or sensitive data from being delivered to the one or more non-production systems. computer-executable.

19. The one or more physical computer-readable storage media of claim 17, wherein the policy constraints specify customized network traffic loads to specify how network traffic should be intercepted and duplicated to produce a desired network traffic load.

20. The method of claim 1, wherein the policy constraints specify changes to be made to duplicated network traffic.
